(19) United States
(12) Patent Application Publication
(10) Pub. No.: US 2025/0128606 A1
(43) Pub. Date: Apr. 24, 2025

(54) PANTOGRAPH EQUIPPED WITH A LOW-VOLTAGE SUPPLY SYSTEM

(71) Applicant: Faiveley Transport Tours, Saint-Pierre-Des-Corps (FR)

(72) Inventor: Jerome Lefort, Saint Pierre des Corps (FR)

(73) Assignee: Faiveley Transport Tours, Saint-Pierre-Des-Corps (FR)

(21) Appl. No.: 18/718,252

(22) PCT Filed: Dec. 9, 2022
(86) PCT No.: PCT/EP2022/085187

§ 371 Date: Jun. 10, 2024

(30) Foreign Application Priority Data
Dec. 10, 2021 (EP) FR2113290

(51) Int. Cl. B60L 5/30; B60L 5/24; B60L 5/26; B60L 8/00

(52) U.S. Cl. CPC B60L 5/30; B60L 5/24; B60L 5/26; B60L 8/00

(57) ABSTRACT

The invention consists of a pantograph (2) comprising a pantograph head (+) with two bows (10), and comprising a low-voltage supply system having at least one transducer (15, 20) that converts the mechanical energy generated by oscillating movements of the pantograph head (4) with at least two bows (10) into electrical energy: each bow (10) is connected mechanically to a suspension arm (26), said suspension arm (26) being connected mechanically to an elastic link (25), and said elastic link (25) being connected by a joint (24) to the end of an upper arm (7) of the pantograph (4), wherein at least one first transducer is connected mechanically on one side to said suspension arm (26) connected to a first bow (10) and on the other side to the joint (24).

The present invention relates to a low-voltage supply system intended to be installed on a pantograph for electric vehicles supplied by catenaries, such as electric trains or urban passenger-transport vehicles (trams, metro, etc).

It thus relates to a pantograph equipped with such a low-voltage supply system

The invention applies in particular to the autonomous supply of low-voltage devices installed in an electric vehicle supplied by catenaries and located at a pantograph. In fact it is usual for sophisticated measuring devices to be installed on the pantograph for measuring, during the movements of the vehicle supplied by the pantograph, various electrical, optical, thermal and mechanical parameters related to the interaction between the pantograph and the catenaries. These measurements can be used for maintaining the catenaries and detecting and locating problems at the catenaries, such as lateral positioning defects or mechanical tension defects on the catenaries. The permanent monitoring of the catenaries by the vehicles travelling on the track makes it possible to intervene preventatively before the occurrence of a catenary failure that might cause significant interruptions to traffic.

So that the measuring devices operate correctly, it is essential to provide a stable and reliable low-voltage supply to these measuring devices. However, low-voltage supply to these devices is not simple since the pantographs providing the electrical power supply to the vehicles are at high voltage. In fact, since the catenary electrical voltages can range from 750 to 25,000 V direct current (DC) or alternative current (AC), they require efficient galvanic isolation of all the electrical systems located in proximity to the pantograph. Thus the electrical supply to the measuring devices poses electrical problems, resolving which is complex and expensive.

As explained below, various solutions are currently employed for providing the low-voltage electrical supply to devices located at the pantographs.

A high-voltage isolating transformer can be used for this purpose. Nevertheless, mechanically and electrically incorporating it on the roof of the vehicle at the pantograph is tricky. This is because these transformers are relatively bulky and the attachment thereof to the roof must be sufficiently strong to withstand the mechanical stresses resulting from accelerations in all spatial directions during the movements of the vehicle. These mechanical stresses are all the greater because of the significant weight of the transformers. In addition, high-voltage isolating transformers are expensive and add a risk of high-voltage short-circuit in the event of failure thereof.

A supply by batteries can also be envisaged. Nevertheless, this solution requires frequent accesses to the roof for replacing discharged batteries, requiring cuts to and safety of the high-voltage. In addition, premature discharge of the batteries or a problem in replacing the batteries cannot be excluded, with the risk of loss of measurements. Solutions exist for increasing the operating time of the batteries such as coupling thereof to solar panels or to a wind turbine, without completely eliminating the need to replace them regularly.

The aim of the present invention is to propose a pantograph with an improved low-voltage supply system for providing operation of the electronic devices located at the pantograph and which solves at least some problems of the known solutions.

For this purpose, the invention relates to a pantograph comprising a pantograph head with two bows, and comprising a low-voltage supply system, comprising at least one transducer converting the mechanical energy generated by oscillatory movements of the pantograph head with at least two bows into electrical energy;
each bow being mechanically connected to a suspension arm, said suspension arm being mechanically connected to an elastic link, and said elastic link being connected by a joint to the end of a top arm of the pantograph,
wherein at least one first transducer is mechanically connected firstly to the suspension arm connected to a first bow and secondly to the joint.

Thus, the supply system according to the invention is completely autonomous and inexpensive to implement and requires little or no regular maintenance. In addition, this supply system is independent of the electrical power supply of the vehicle. It is therefore suited both to electric vehicles supplied by an alternating electric current and to those supplied by a direct current.

More particularly, the transducer converts the mechanical energy generated by vibratory movements of the pantograph.

Said vibratory movements are, generally, complex vibratory movements caused by the movements of the elements of the pantograph, and/or of the internal movable parts thereof, and/or of the catenary. Generally, said vibratory movements are a combination of linear and/or rotary movements, in one or more spatial directions.

In particular, said vibratory movements are caused by the rubbing of the bow on a catenary.

Said vibratory movements can be linear, substantially vertical, and/or substantially rotary.

The transducer converts the mechanical energy generated by the oscillatory movements of a pantograph head with at least two bows.

The arrangement of at least one first transducer between a suspension arm and the joint makes it possible in particular to recover the energy from complex vibratory rotary movement components. Such an energy recovery is particularly significant in the case of a pantograph head with double bow.

In practice, the first transducer can be mechanically connected firstly to said suspension arm connected to a first bow and secondly to an arm common to the two bows. The common arm is connected by a joint to the top pantograph arm. Thus, indirectly, the transducer is also mechanically connected to the joint.

In such an embodiment, the elastic link can advantageously be in the form of a “spring box”.

According to a particular embodiment, at least one second transducer is disposed between the suspension arm connected to a second bow, and the joint.

According to a variant, the at least one transducer is an induction transducer.

Preferentially, the transducer comprises a plunger mechanically connected to one of the suspension arms and generating a magnetic field in an induction coil of the transducer.

According to another variant, the at least one transducer is a piezoelectric module subjected to a mechanical stress generated by the movement of one of the suspension arms.

Preferentially, the supply system furthermore comprises an electrical processing device comprising a unit for storing the electrical energy supplied by the at least one transducer.

By virtue of these features, the electrical energy generated by the transducer is stored for supplying the low-voltage devices. In particular, the energy stored in the unit storing the electrical energy can be stored when the supply system is producing no, or little, energy, i.e. when the moving part of the pantograph is not, or only a little, in movement.

Other features and advantages of the invention are revealed by the following description of non-limitative example embodiments of the various aspects of the invention. The description refers to the accompanying figures, which are also given by way of non-limitative example embodiments of the invention:

FIG. 1 shows schematically a first type of pantograph equipped with an induction coil,

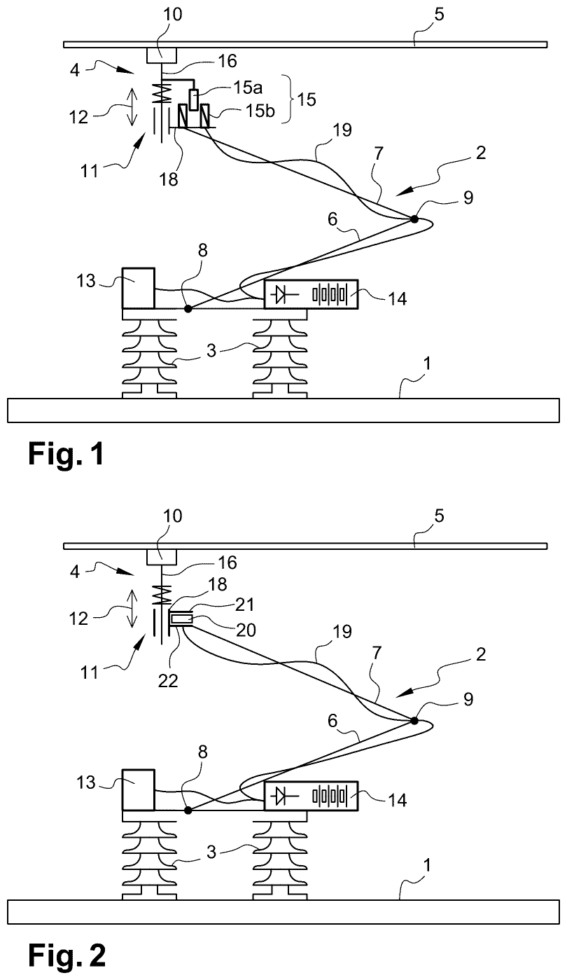

FIG. 2 shows schematically a first type of pantograph equipped with a piezoelectric ceramic,

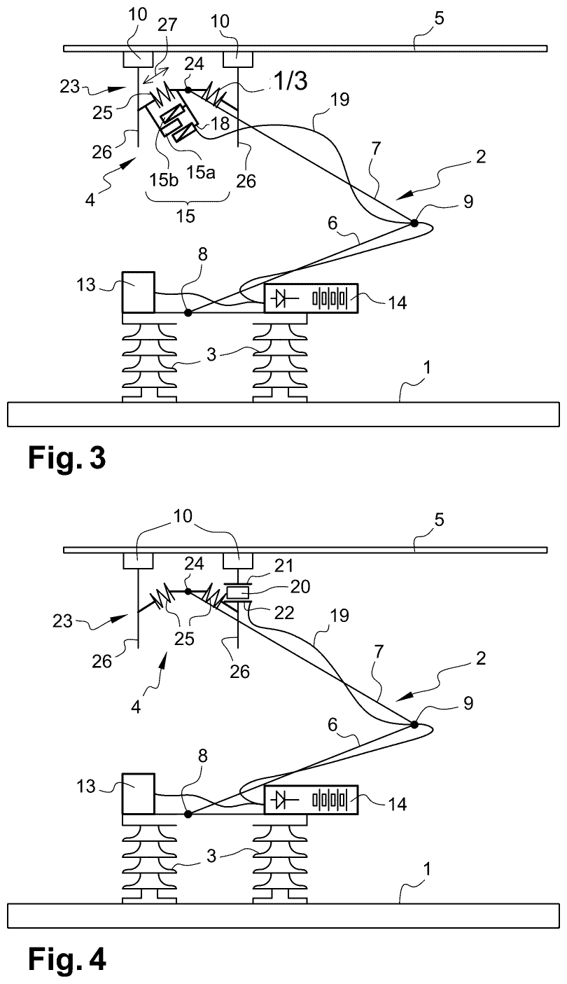

FIG. 3 shows schematically a second type of pantograph equipped with an induction coil,

FIG. 4 shows schematically a second type of pantograph equipped with a piezoelectric ceramic, and

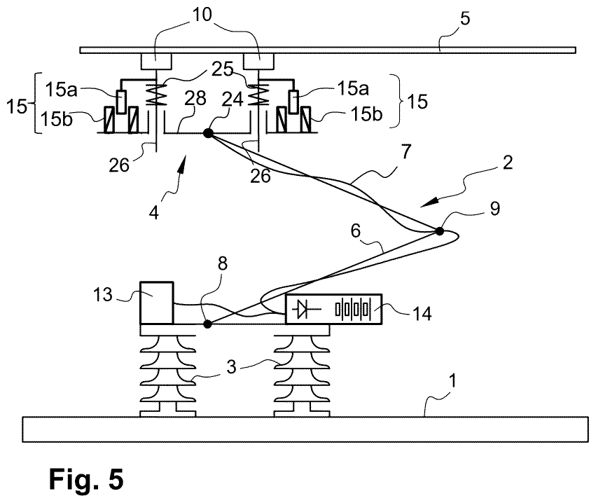

FIG. 5 shows schematically a second type of pantograph according to a variant embodiment.

In order to monitor the operation of the pantographs providing the electrical power energy supply to vehicles, such as for example train locomotives, automotive rail vehicles or trams, and the state of the catenaries under which the pantographs are in contact, electrical devices are installed on the roof of these vehicles at the pantograph.

FIG. 1 shows the roof 1 of a locomotive on which a pantograph 2 is mounted by means of electrical insulators 3. The pantograph 2 is an articulated device that can be either in folded position or in erected position. It is in this erected position, as shown in FIG. 1, that the pantograph can pick up the electric current providing the power supply to the locomotive by a pantograph head 4 rubbing on a catenary 5.

In electric rail equipment, the pantographs were usually in a diamond shape. At the present time, modern pantographs consist only of a bottom arm 6 connected in an articulated fashion to a top arm 7. Firstly, the bottom arm 6 is mechanically connected by one of its ends to the roof 1 of the locomotive, via a first joint 8. The arm 6 is insulated from the roof 1 of the locomotive by means of insulators 3. Secondly, it is connected by its other end to one of the ends of the top arm 7, via a second joint 9. The top arm 7 supports, at its other end, the head of the pantograph 4. Modern pantographs can have an amplitude of vertical movement ranging up to 3.8 metres. The pantograph is actuated to pass from the folded position to the erected position by a lifting device (not shown) that may be pneumatic or electric, return to the folded position generally taking place by gravity.

The pantograph head 4 includes a bow 10 that rubs on the catenary 5 when the pantograph 2 is in the erected position. A rubbing strip (not shown) generally made from carbon is mounted on the top face of the bow 10 so as to rub on the catenary 5 to pick up the electric current that is passing therethrough. A control device ensures that the lifting device of the pantograph 2 generates a controlled pressure of the bow 10 on the catenary 5. Nevertheless, in order to compensate for the differences in height of the catenary 5 on the path of the locomotive and the presence on the catenary 5 of elements necessary to the suspension thereof, the pantograph head 4 includes a suspension 11 movably connecting the bow 10 to the top arm 7 of the pantograph 2.

The height differences of the catenary 5 and the mechanical defects thereof cause a substantially vertical vibratory movement 12 that is amplified by the speed of the train. This substantially vertical vibratory movement 12 is compensated for by the suspension 11, which prevents the bow 10 becoming detached from the catenary 5. This is because such detachments cause electric arcs that are harmful for the behaviour of the catenary and of the rubbing strip, which cause electromagnetic nuisances. Losses of contact between the bow and the catenary may cause stoppage of the traction chain.

One or more electrical devices 13 are mounted in the vicinity of the first joint 8 of the bottom arm 6 of the pantograph 2, or at any other point on the pantograph 2. These electrical devices 13 can fulfil various functions. These are usually measuring systems supplied at low voltage.

In the example embodiment illustrated in FIG. 1, the electric current necessary for this low-voltage supply is generated by an induction transducer 15 converting the substantially vertical vibrations 12 of the bow 10 into electrical energy.

The low-voltage electric current generated by the induction transducer 15 is rectified and managed by an electrical processing device 14 before supplying the electrical devices 13.

The electrical processing device 14 is composed for example of a rectification system and a unit for storing the electrical energy supplied by the induction coil 15b.

It furthermore includes a controller that manages the electrical energy thus generated as well as the internal operation of the low-voltage electrical supply system described above so that it can supply any kind of electrical device 13.

The induction transducer 15 includes a plunger 15a generating a magnetic field, such as a ferromagnetic plunger or a magnet, mechanically connected to a first moving part 16 of the suspension 11 attached to the bow 10. The induction transducer 15 also includes an induction coil 15b mechanically connected to a second part 18 of the suspension 11 connected to the top arm 7 of the pantograph 2. The vibratory movement 12 of the bow 10 with respect to the top arm of the pantograph is transmitted to the first part 16 of the suspension 11 that drives the plunger 15a, which in its turn vibrates inside the induction coil 15b. Thus the vertical vibratory movement 12 is converted into electrical energy that is transmitted by an electrical connection to the electrical processing device 14, the latter being able to be located either at the base of the pantograph or in the immediate vicinity of the induction transducer 15. In particular, when the induction transducer and the electrical processing device 14 are distant, the electrical connection takes the form of wiring 19, able to be guided along the bottom arm 6 and top arm 7.

FIG. 2 shows a second example embodiment in which the induction transducer is replaced by a piezoelectric transducer consisting of a piezoelectric module 20.

In this example embodiment, it is the direct piezoelectric effect, i.e. the polarisation of a piezoelectric component when it is stressed, that is used for generating electrical energy.

As illustrated in FIG. 2, the piezoelectric module 20 is mounted between a first armature 21 mechanically connected to the second part of the suspension 18 and a second armature 22 mechanically connected to the top arm 7 opposite to the one connected to the second joint 9. The piezoelectric module can consist of a piezoelectric ceramic or other piezoelectric material, such as piezocomposites.

When the locomotive moves under the catenary 5, the vertical vibratory movement 12 of the bow 10 is transmitted to the suspension 11. This vertical vibratory movement 12 is transmitted to the first armature 21, which thus compresses the piezoelectric module 20 against the second armature 22. This mechanical compression of the piezoelectric module is converted into a voltage that generates the current transmitted to the electrical processing device 14 through the electrical connection, in order to supply the electrical device 13.

FIG. 3 shows a second type of pantograph 2 in which the pantograph head 4 is provided with two bows 10 simultaneously rubbing on the catenary 5. The two bows 10 are mechanically secured to an oscillating suspension 23 connected by a third joint 24 to the end of the top arm 7 opposite to the one connected to the second joint 9. Elastic links 25 mechanically connect the third joint 24 to movable suspension arms 26. These elastic links can comprise helical springs, conical elastic washers, or any other elastic element allowing axial compression and relaxation between the suspension arm 26 and the third joint 24. Each suspension arm 26 is mechanically connected to one of the bows 10.

In a variant, not illustrated, each suspension arm 26 can comprise a vertical suspension similar to that of the pantograph head 4 illustrated in FIGS. 1 and 2.

In the example embodiment illustrated in FIG. 3, the transducer consists of firstly an induction coil 15b mechanically connected to the end of one of the elastic links 25 located next to the third joint 24, and secondly a plunger 15a generating a magnetic field, such as a ferromagnetic plunger, mechanically connected to the other end of the elastic link 25 located next to the suspension arm 26.

In a variant, not illustrated, an induction coil 15b and a plunger 15a can be mounted on each of the elastic links 25.

In this context, the mechanical irregularities and the differences in level of the catenary 5 cause vibrations at the bows 10 that make the oscillating suspension 23 oscillate about the third joint 24 and make the elastic links 25 compress and expand. These compression/expansion movements 27 of the elastic links 25 make the plunger 15a vibrate inside the induction coil 15b. The vibration of the plunger is converted into a current in the induction coil 15b that is transmitted by the electrical connection to the electrical device 13 via the electrical processing device 14. If necessary, the plunger 15a and the induction coil 15b mounted on an elastic link 25 can be duplicated by a second plunger/coil assembly mounted on the other elastic link 25. This device with one or two induction transducers mounted on the elastic link 25 can also be supplemented by an induction transduction device mounted on one or both suspension arms 26 as illustrated in FIGS. 1 and 2.

In this way a low-voltage supply concept is obtained, adaptable to various electrical power levels for supplying various types of electrical device 13.

FIG. 4 shows another example embodiment of a low-voltage supply for a pantograph 2 with double bows 10 in which one or both suspension arms 26 comprise a piezoelectric module 20 mounted between a first armature 21 mechanically connected to the end of the suspension arm 26 located next to the bow 10 and a second armature 22 located next to the suspension arm 26 connected to the corresponding elastic link 25. Alternatively, the configuration of the piezoelectric device illustrated in FIG. 2 can also be used as a variant for a pantograph 2 with double bows 10 as illustrated in FIG. 4. The piezoelectric module 20 can be of the same type as the one described above in relation to FIG. 2.

In this context, the mechanical irregularities and the differences in level of the catenary 5 cause firstly vibrations at the bows 10 that make the oscillating suspension 23 oscillate about the third joint 24 and secondly mechanical compression stresses in the suspension arms 26 that compress the piezoelectric module 20.

Thus, the mechanical stresses caused in the piezoelectric module 20 generate a current that is transmitted to the electrical device 13 through the electrical connection via the electrical processing device 14.

FIG. 5 shows another example embodiment of a low-voltage supply for a pantograph 2 with double bows 10. Here, each of the bows 10 is connected to a common arm 28, which is itself connected by a joint 24 to the arm 7 of the pantograph.

Each bow 10 is connected to the common arm 28 by means of an elastic link 25. Here, the elastic link shown in FIG. 5 is a “spring box”, comprising a spring mechanically connected on one side to a suspension arm 26 of a bow 10, and mechanically connected on the other side to the common arm 28.

In the example illustrated, the transducer is an induction transducer 15. The plunger 15a is here mechanically connected to the bow, and the induction coil 15b is mechanically connected to the common arm 28.

In this embodiment, the component of the oscillatory movement of the bow head the energy of which is recovered is mainly a linear component.

This embodiment has the advantage of being able to be implemented easily, by virtue of the use of “spring boxes”.

As with the aforementioned embodiments, an induction transducer in this embodiment can be replaced by a piezoelectric transducer, connected firstly to a suspension arm 26 secured to the bow 10, and secondly to the common arm 28. Induction transducers or piezoelectric transducers are devices that are commonly employed, inexpensive and easy to implement. Once installed, the low-voltage supply systems described above are reliable and require no or little maintenance, which gives rise to operating economies. In addition, as indicated above, a pantograph can be equipped with one or more transducers in the same category, or a combination of induction and piezoelectric transducers mounted on the elastic links 25 and/or on the suspension arms 26 and/or any other point on the pantograph causing a movement. Thus, the description made above does not limit the use of energy recovery to a single technology (induction or piezoelectric). The use of both at least one induction transducer and at least one piezoelectric transducer can be envisaged for increasing even further the quantity of energy recovered. In the same way, the description does not limit the arrangement of the transducer or transducers, whether they be induction and/or piezoelectric, at the pantograph head. For example, it can be envisaged disposing a transducer at the angle formed between the arms 6 and 7 of the pantograph, in particular at the joint 9, so as to convert the relative movement at said joint into electrical energy. In an identical manner, it can be envisaged disposing a transducer at the joint 8.

Such an arrangement of a transducer is particularly advantageous when the pantograph 2 comprises one or more rotary suspensions, for example arranged at the joint 9 between the arms 6 and 7 of the pantograph.

Although in the above description the particular aspects of the invention, in particular the use of one or more transducers, have been described in the context of an electric-traction locomotive supplied by an alternating or direct voltage transmitted by the pantograph and catenary, they could be implemented in other configurations, in particular with other types of transport vehicle, such as for example urban passenger-transport vehicles such as trams or trolleybuses.

1. A pantograph comprising:
a pantograph head with two bows; and
a low-voltage supply system comprising:
at least one transducer converting mechanical energy generated by oscillatory movements of the pantograph head with at least two bows into electrical energy,
wherein each bow is mechanically connected to a suspension arm, the suspension mechanically connected to an elastic link, the elastic link is connected by a joint to an end of a top arm of the pantograph head,
wherein at least one first transducer is mechanically connected firstly to the suspension arm connected to a first bow and secondly to the joint.

2. Pantograph The pantograph according to claim 1, wherein at least one second transducer is disposed between the suspension arm (26) connected to a second bow (10), and the joint (24).

3. The pantograph according to claim 1, wherein the at least one transducer is an induction transducer.

4. The pantograph according to claim 3, wherein the transducer comprises a plunger mechanically connected to one of the suspension arms and generating a magnetic field in an induction coil of the transducer.

5. The pantograph according to claim 1, wherein the least one transducer is a piezoelectric module subjected to a mechanical stress generated by movement of one of the suspension arms.

6. The pantograph according to claim 1, wherein the low-voltage supply system further comprises an electrical processing device, and wherein the electrical processing device comprises a unit for storing the electrical energy supplied by the at least one transducer.
